(19) United States
(12) Patent Application Publication
(10) Pub. No.: US 2016/0222208 A1
(43) Pub. Date: Aug. 4, 2016

(54) CARBON LONG FIBER REINFORCED THERMOPLASTIC RESIN COMPOSITION AND MOLDED ARTICLE MANUFACTURED USING THE SAME

(71) Applicants: Hyundai Motor Company, Seoul (KR); Kia Motors Corporation, Seoul (KR); GS CALTEX, Seoul (KR)

(72) Inventors: Sang Sun Park, Anyang (KR); Kyung Min Yu, Seoul (KR); Kie Youn Jeong, Hwaseong (KR); Seok Hwan Kim, Suwon (KR); Hyung Tak Lee, Daejeon (KR); Woong Jae Boo, Yongin (KR); Jong Tae Seo, Daejeon (KR)

(21) Appl. No.: 14/967,705

(22) Filed: Dec. 14, 2015

(30) Foreign Application Priority Data
Feb. 2, 2015 (KR) 10-2015-0016106

(51) Int. Cl. C08L 77/06

(52) U.S. Cl. CPC C08L 77/06

(57) ABSTRACT

The present invention relates to a thermoplastic resin composition and a molded article manufactured using the thermoplastic resin composition. Particularly, the thermoplastic resin composition may be reinforced with the carbon fiber. Accordingly, the thermoplastic resin composition may be obtained by mixing a carbon fiber, a silane-based coupling agent and a thermoplastic elastomer to a polyamide-6 polymer having low specific gravity, such that weight thereof may be reduced and economical efficiency may be improved. Further, parts assembly efficiency and stability of the injection molded product from the thermoplastic resin composition of the present invention may be improved by minimizing deformation after injection molding due to improved rigidity, durability and dimensional stability thereof. The thermoplastic resin composition may be used for parts of vehicle exterior material such as a panorama sunroof frame.

### CROSS-REFERENCE TO RELATED APPLICATION

This application claims under 35 U.S.C. §119(a) the benefit of Korean Patent Application No. 10-2015-0016106 filed on Feb. 2, 2015, the entire contents of which are incorporated herein by reference.

### TECHNICAL FIELD

The present invention relates to a thermoplastic resin composition that is reinforced by a carbon fiber, and a molded article manufactured using the thermoplastic composition. The thermoplastic resin composition may be obtained by mixing a carbon fiber, a silane-based coupling agent and a thermoplastic elastomer to a polyamide-6 polymer having low specific gravity, thereby reducing weight and improving economical efficiency. Further, the molded article manufactured using the thermoplastic resin composition may improve parts assembly efficiency and stability by minimizing deformation after injection molding due to substantially improved rigidity, durability and dimensional stability and thus, the molded articles can be used as parts for vehicle exterior material such as a panorama sunroof frame.

### BACKGROUND

Recent motor industry has focused on the weight reduction, gentrification and being eco-friendly. Particularly, the motor industry consistently has tried to reduce weight of a vehicle, which significantly influences on fuel efficiency and driving performance of the vehicle.

A panorama sunroof of a vehicle is manufactured for giving internal ventilation and wide openness assessment to a vehicle, and glass and an electric motor and the like are attached to the frame. The panorama sunroof frame needs high physical properties for enduring the load of peripheral parts and impact from outside, and thus, steel materials has been mainly used.

Recently, a steel-inserted engineering plastic for vehicle weight reduction has been developed. For example, when polybutyleneterephthalate reinforced by a glass fiber is used, the weight of the steel-inserted plastic can be reduced of about 30% or greater than that of the steel materials.

However, when the polybutyleneterephthalate/glass fiber material is applied to the vehicle parts, deformation may occur after injection. Further, the weight thereof may not be sufficiently reduced as the content of the glass fiber is increased to give rigidity required to the panorama sunroof frame and specific gravity is increased.

In the related arts, Japanese Patent Publication No. 0130491 discloses a polyamide resin composition, which is much used to parts for machines, electronics, vehicle and the like due to its excellent impact resistance, glossiness, and dimensional stability. Further, Japanese Patent Laid-Open Publication No. 2012-509381 discloses a composition wherein polyamide and a reinforcing agent are combined, which has excellent mechanical strength and used to a vehicle, construction, sports goods and the like. Further, Japanese Patent Laid-Open Publication No. 2011-529986 discloses a polyamide-based high temperature resin composition, which has chemical resistance, processability and heat resistance, and used to vehicle and battery/electronics fields.

However, such resin compositions have not improved processability, mechanical strength, heat resistance and impact resistance by adding a silane-based coupling agent or a thermoplastic elastomer.

Thus, development of materials is needed, for example, by applying a carbon fiber which may have sufficient dimensional stability for preventing deformation problem after injection molding and may improve rigidity with reduced amount.

The above information disclosed in this Background section is only for enhancement of understanding of the background of the invention and therefore it may contain information that does not form the prior art that is already known in this country to a person of ordinary skill in the art.

### SUMMARY

In preferred aspects, the present invention provides a thermoplastic resin composition that may be obtained by mixing a carbon fiber, a silane-based coupling agent and a thermoplastic elastomer to a polyamide-6 polymer having low specific gravity. As such, the weight of the composition may be reduced and economical efficiency thereof may be improved. Further, deformation after injection molding the thermoplastic resin may be minimized due to improvements in physical properties such as dimensional stability, mechanical strength and durability.

In one aspect, provided is a thermoplastic resin composition that may be reinforced by a carbon fiber, such that weight of the composition may be reduced, economical efficiency may be improved, and further, physical properties such as dimensional stability, mechanical strength and durability may be improved.

In another aspect, the present invention provides a molded article comprising the thermoplastic resin composition as described above, such that part assembly efficiency and stability may be improved by minimizing deformation after injection molding.

In an exemplary embodiment, the thermoplastic resin composition may include: a polyamide-6 polymer in an amount of about 45 to 93 wt %; a carbon-fiber in an amount of about 5 to 40 wt %; a silane-based coupling agent in an amount of about 1 to 5 wt %; and a thermoplastic elastomer in an amount of about 1 to 10 wt %, based on the total weight of the thermoplastic resin composition. Particularly, the carbon fiber may have a mean section diameter of about 5 to 15 μm and a length of about 5 to 15 mm, and the thermoplastic elastomer may have a melt index of about 10 to 40 g/10 min at a temperature of about 230° C. and at a load of about 2.16 kg.

As used herein, the “mean section diameter” may be determined by a mean value of diameters from the carbon fiber cross sections.

The polyamide-6 polymer may have a number average molecular weight of about 20,000 to 70,000.

The carbon-fiber may be made from polyacrylonitrile (PAN), Pitch or a mixture thereof.

The carbon-fiber may suitably comprise a sizing material 0.1 to 3 wt % based on the total weight of the carbon fiber. In particular, the sizing material may be at least one selected from the group consisting of a urethane resin, an acryl resin, a styrene resin and an epoxy resin.

The silane-based coupling agent may be a compound expressed by the following Chemical Formula.

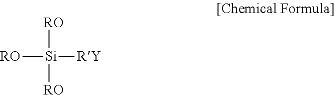

In the Chemical Formula, each R and R′ are the same or different to each other, and are a hydrogen atom or an optionally substituted alkyl group suitably containing from 1 to 30 or 1 to 20 carbon atoms, and Y is any one functional group selected from the group consisting of vinyl group, amino group, methacryl group, epoxy group and mercapto group with each such Y group suitably containing 1 to 20 carbon atoms or a to 10 carbon atoms.

The thermoplastic elastomer may be an ethylene-α-olefin copolymer having carbon number (α) of 4 or greater, a styrene-diene copolymer or a mixture thereof.

Further provided is a molded article that comprises the thermoplastic resin composition as described above. Also provide is a vehicle that comprising the molded article that comprises the thermoplastic resin composition.

In an exemplary embodiment, the molded article may be a panorama sunroof frame for a vehicle.

Other aspects and preferred embodiments of the invention are discussed infra.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The thermoplastic resin composition of the present invention may be reinforced with carbon fibers. The thermoplastic resin composition may include: (A) the polyamide-6 polymer in an amount of about 45 to 93 wt %; (B) the carbon fiber in an amount of about 5 to 40 wt %; (C) the silane-based coupling agent in an amount of about 1 to 5 wt %; and (D) the thermoplastic elastomer in an amount of about 1 to 10 wt %. The polyamide-6 polymer may be obtained by ring opening polymerization of ε-caprolactam. The carbon fiber may have a mean section diameter of 5 to 15 μm and length of 5 to 15 mm, and the thermoplastic elastomer may have a melt index of 10 to 40 g/10 min at a temperature of about 230° C. and a load of about 2.16 kg.

According to an exemplary embodiment of the present invention, the thermoplastic resin composition may maximize weight reduction and economical effects by embodying low specific gravity, and may improve parts assembly efficiency and stability by minimizing deformation after injection molding due to improved dimensional stability and physical property balance such as high rigidity and durability, as compared to the existing polybutyleneterephthalate/glass fiber material.

The thermoplastic resin composition may include the following components.

(A) Polyamide-6

Polyamide-6 polymer is obtained from ring opening polymerization of ε-caprolactam. The polyamide-6 polymer, as used herein, may be included in the composition to reduce weight and to improve mechanical strength, impact resistance, heat resistance and fluidity at the same time. In particular, the polyamide-6 polymer may have a specific gravity of about 1.12 to 1.16, such that the weight of the resin composition may be reduced. Further, the polyamide-6 polymer may provide improved physical properties such as dimensional stability, mechanical strength, impact resistance, heat resistance and the like such that deformation after injection molding may be minimized.

The polyamide-6 polymer may have a number average molecular weight of about 20,000 to 70,000, or alternatively, the polyamide-6 polymer having a number average molecular weight of about 20,000 to 70,000 may be used solely or in a mixture of two or more other polyamide-6 polymers having different molecular weight. When the number average molecular weight is less than about 20,000, mechanical strength and impact resistance may be deteriorated, and when the number average molecular weight is greater than about 70,000, mechanical properties may be deteriorated by reduction of impregnating property of the carbon-fiber during a pultrusion impregnation process and fluidity during the injection processing may not be sufficient thereby deteriorating molding.

Particularly, the polyamide-6 polymer may be included in an amount of about 45 to 93 wt %, based on the total weight of the thermoplastic resin composition. When the content of the polyamide-6 polymer is less than about 45 wt %, impact resistance may be deteriorated, and when the content thereof is greater than about 93 wt %, mechanical strength may be deteriorated. Preferably, the polyamide-6 polymer may be included in an amount of about 60 to 93 wt %, or particularly in an amount of 70 to 90 wt % based on the total weight of the thermoplastic resin composition.

(B) Carbon Fiber

The carbon-fiber may be included to the thermoplastic resin composition to reduce weight and to improve mechanical properties, impact resistance and dimensional stability. The carbon fiber may have fiber or bundle structure having a cross section thereof in a circular, oval or polygonal shape. The carbon fiber may be manufactured using polyacrylonitrile (PAN), Pitch or a mixture thereof as a raw material, and the carbon fiber may have a mean section diameter of about 5 to 15 μm. When the mean section diameter is less than about 5 μm, dispersibility of the carbon fiber may be deteriorated, and when the mean section diameter is greater than about 15 μm, mechanical properties and impact resistance may be deteriorated. Particularly, the carbon-fiber may contain a sizing material in an amount of 0.1 to 3 wt % based on the total weight of the carbon fiber. When the content of the sizing material is less than about 0.1 wt %, dispersibility of the carbon fiber may be deteriorated, thereby reducing mechanical strength, and when the content of the sizing material is greater than about 3 wt %, the sizing material may reduce mechanical strength of the resin itself. This sizing material may be at least one selected from the group consisting of a urethane resin, an acryl resin, a styrene resin and an epoxy resin.

The carbon fiber may be included in an amount of about 5 to 40 wt % based on the total weight of the thermoplastic resin composition. When the content of the carbon-fiber is less than about 5 wt %, mechanical strength and impact resistance may be deteriorated, and when it is greater than about 40 wt %, it may be difficult to reduce weight due to weight increase, and fluidity may be deteriorated. Particularly, the carbon fiber may be included in an amount of 10 to 30 wt %.

(C) Silane-Based Coupling Agent

The silane-based coupling agent may be included to give mechanical strength and impact resistance by improving compatibility of the polyamide-6 polymer and the carbon fiber. Particularly, the silane-based coupling agent may be, but not limited to, a compound expressed by the following Chemical Formula.

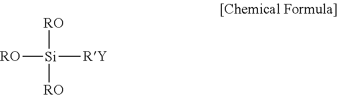

In the Chemical Formula, each R and R′ are the same or different to each other, and are a hydrogen atom or an optionally substituted alkyl group suitably having 1 to 30 or 1 to 20 carbon atoms, and Y is any one functional group selected from the group consisting of vinyl group, amino group, methacryl group, epoxy group and mercapto group with each such Y group suitably containing 1 to 20 carbon atoms or 1 to 10 carbon atoms.

In particular, the silane-based coupling agent having an epoxy group at the end may be applied as the silane-based coupling agent. The silane-based coupling agent may be at least one selected from the group consisting of 3-glycidoxypropyl trimethoxy silane, 3-glycidoxy propylmethyl dimethoxysilane, 2-(3,4-epoxycyclohexyl)ethyltrimethoxysilane and 3-methacryloxy propyl trimethoxy silane, but not limited thereto.

The silane-based coupling agent may be included in an amount of about 1 to 5 wt %, based on the total weight of the thermoplastic resin composition. When the content of the silane-based coupling agent is less than about 1 wt %, mechanical strength and impact resistance may be deteriorated, and the content thereof is greater than about 5 wt %, the low molecular weight coupling agent itself may reduce mechanical strength, and it may reduce processability due to fluidity reduction by increasing melting point of the resin. Particularly, the silane-based coupling agent may be included in an amount of 1 to 3 wt % based on the total weight of the thermoplastic resin.

(D) Thermoplastic Elastomer

The thermoplastic elastomer may be included to give processability, rebound resilience, heat resistance and impact resistance to the thermoplastic resin composition. As the thermoplastic elastomer, an ethylene-α-olefin copolymer having carbon number (α) of 4 or more, a styrene-diene copolymer or a mixture thereof may be used. Particularly, an ethylene-α-olefin copolymer having a carbon number (α) of 4 to 8 may be used as the thermoplastic elastomer. For instance, as the ethylene-α-olefin copolymer having carbon number (α) of 4 or greater, an ethylene butene-1 copolymer (EBM) or an ethylene octene-1 copolymer (EOM) may be used, and the copolymer having the content of alpha (α)-olefin of about 12 to 45 wt % may be used.

The styrene-diene-based copolymer may be a copolymer using at least one styrene-based monomer selected from the group consisting of styrene, α-methylstyrene, α-ethylstyrene and p-methylstyrene, and a diene-based monomer selected from butadiene, isoprene or a mixture thereof. This styrene-diene-based copolymer may be used by polymerization of the styrene-based monomer and the diene-based monomer. For example, the styrene-diene copolymer may be at least one selected from the group consisting of styrene-butylene-styrene block copolymer, styrene-ethylene-butylene-styrene block copolymer, styrene-isoprene-styrene block copolymer, styrene-ethylene-propylene block copolymer and styrene-ethylene-propylene-styrene block copolymer.

The thermoplastic elastomer may be have a melt index of about 10 to 40 g/10 min that is measured at a temperature of about 230° C. and a load of about 2.16 kg. When the melt index is less than about 10 g/10 min, dispersion may be poor due to reduced fluidity, and when the melt index is greater than about 40 g/10 min, impact resistance and side impact may be deteriorated. When the melt index is in the range described above, substantially improved formability may be obtained.

Further, the thermoplastic elastomer may be included in an amount of about 1 to 10 wt %, based on the total weight of the thermoplastic resin composition. When the content of the thermoplastic elastomer is less than about 1 wt %, impact resistance may be deteriorated, and when the content thereof is greater than about 10 wt %, fluidity may be deteriorated and dispersion may be poor. Particularly, the thermoplastic elastomer may be included in an amount of about 3 to 5 wt % based on the total weight of the thermoplastic resin composition.

(E) Additives

The thermoplastic resin composition may further comprise general additives. For example, the additives may be an antioxidant and an antistatic agent. The antioxidant may be at least one selected from the group consisting of a phenol-based antioxidant, a phosphite-based antioxidant and a thiopropionate synergist, and these or other additives may be easily used by the ordinary skilled person in the art.

In an exemplary embodiment, provided is a method for manufacturing the thermoplastic resin composition of the present invention. Particularly, the method may include: mixing the composition by using a general melting-kneading machine such as a bambury mixer, a single screw extruder, a twin screw extruder and a multi-screw extruder, a pultrusion molding machine and the like; and molding after mixing. The molding may be performed by a generally used method in the related art, such as extrusion molding, compression molding, injection molding and the like, but not limited thereto.

In an exemplary embodiment, the present invention provides a molded article, which may be manufactured by comprising the thermoplastic resin composition described above. In particular, the molded article may be a vehicle part, such as panorama sunroof frame of a vehicle.

Thus, the thermoplastic resin composition according to various exemplary embodiments of the present invention may have reduced weight and economical efficiency due to reduced specific gravity of the composition. Further, the thermoplastic resin composition may improve parts assembly efficiency and stability, by minimizing deformation after injection molding due to improved rigidity, durability and dimensional stability, as compared to the conventionally used polybutyleneterephthalate/glass fiber material. As such, it may be suitably used as parts for a vehicle exterior material such as a panorama sunroof frame by using thereof.

### EXAMPLES

The following examples illustrate the invention and are not intended to limit the same.

Examples 1 to 4 and Comparative Examples 1 to 8

For Examples 1 to 4 and Comparative Examples 1 to 8, the ingredients listed below were prepared, mixed at the composition ratio listed in the following Table 1, extruded using a twin screw extruder and a pultrusion molding machine, and then injected molded to manufacture a specimen for measuring physical properties.

[Materials]

(A) Polyamide-6: Polyamide-6 having a number average molecular weight of about 50,000 was used.

(B1) Carbon fiber (longer length): Carbon fiber, which was made from polyacrylonitrile (PAN), had a mean section diameter of about 7 μm, a length of about 10 mm, and included a sizing material of about 1 wt %, was used.

(B2) Carbon fiber (shorter length): Carbon fiber, which was made from polyacrylonitrile (PAN), had a section diameter of about 7 μm, a length of about 2 mm, and included a sizing material of 1 wt %, was used.

(C1) Coupling agent: 3-glycidoxypropyl trimethoxy silane was used.

(C2) Coupling agent: modified polypropylene that included anhydrous maleic acid of about 8 wt % grafted to polypropylene was used.

(D1) Thermoplastic elastomer: a thermoplastic elastomer, which had a melt index of about 15 g/10 min measured at a temperature of 230° C. and at a load of 2.16 kg and included an ethylene butene-1 copolymer (EBM), was used.

(D2) Thermoplastic elastomer: a thermoplastic elastomer, which had a melt index of 10 g/10 min measured at a temperature of 230° C. and at a load of 2.16 kg, and included an ethylene butene-1 copolymer (EBM), was used.

(D3) Thermoplastic elastomer: a thermoplastic elastomer, which had a melt index of 40 g/10 min measured at a temperature of 230° C. and at a load of 2.16 kg, and included an ethylene butene-1 copolymer (EBM), was used.

(D4) Thermoplastic elastomer: a thermoplastic elastomer, which had a melt index of 1 g/10 min measured at a temperature of 230° C. and a load of 2.16 kg and included an ethylene butene-1 copolymer (EBM), was used.

(D5) Thermoplastic elastomer: a thermoplastic elastomer, which had a melt index of 50 g/10 min measured at a temperature of 230° C. and a load of 2.16 kg and included an ethylene butene-1 copolymer (EBM), was used.

TABLE 1

| | | Example | | | | Comparative Example | | | | | | | |
|---|---|---|---|---|---|---|---|---|---|---|---|---|---|
| Section | | 1 | 2 | 3 | 4 | 1 | 2 | 3 | 4 | 5 | 6 | 7 | 8 |
| Polyamide-6 (A) | | 72 | 70 | 72 | 72 | 72 | 72 | 74.5 | 65 | 76.5 | 62 | 72 | 72 |
| Carbon Fiber | (B1) | 20 | 23 | 20 | 20 | — | 23 | 20 | 20 | 20 | 20 | 20 | 20 |
| | (B2) | — | — | | | 20 | — | — | — | — | | | |
| Coupling Agent | (C1) | 3 | 4 | 3 | 3 | 3 | — | 0.5 | 10 | 3 | 3 | 3 | 3 |
| | (C2) | — | — | | | — | 4 | — | — | — | | | |
| Thermoplastic | (D1) | 5 | 3 | | | 5 | 3 | 5 | 5 | 0.5 | 15 | | |
| Elastomer | (D2) | | | 5 | | | | | | | | | |
| | (D3) | | | | 5 | | | | | | | | |
| | (D4) | | | | | | | | | | | 5 | |
| | (D5) | | | | | | | | | | | | 5 |

| | | | | | | | | | | | | |
|---|---|---|---|---|---|---|---|---|---|---|---|---|
| Total (wt %) | 100 | 100 | 100 | 100 | 100 | 100 | 100 | 100 | 100 | 100 | 100 | 100 |

### Test Example

In order to examine physical properties and processability and the like of the molded material manufactured by using the carbon fiber reinforcing thermoplastic resin, which was manufactured in Examples 1 to 4 and Comparative Examples 1 to 8, the following items were measured, and then the results were shown in the following Tables 2 and 3.

(1) Tensile strength (kgf/cm²): Measured according to ASTM D638.

(2) Elongation (%): Measured according to ASTM D638.

(3) IZOD impact strength (kgf·cm/cm): Measured according to ASTM D256 at a ¼″ notched condition at room temperature (23° C.).

(4) Flexural strength (kgf/cm²): Measured according to ASTM D790.

(5) Flexural modulus (kgf/cm²): Measured according to ASTM D790.

(6) Heat deformation temperature (° C.): Heat deformation temperature was measured according to ASTM D648 by applying surface pressure of 1.82 MPa.

(7) Rockwell Hardness: Measured according to ASTM D785 with R-Scale.

(8) Fluidity (mm): A specimen was injected to a die in the form of spiral using an LS Mtron injection machine at conditions of cylinder temperature of 280° C., die temperature of 50° C., injection pressure of 60 MPa, injection speed of 200 mm/sec and discharging pressure of 1 MPa, and the molded length was measured and compared.

TABLE 2

| | Example | | | |
|---|---|---|---|---|
| Section | 1 | 2 | 3 | 4 |
| Tensile Strength | 2,100 | 2,500 | 2,100 | 2,000 |
| (kgf/cm²) | | | | |
| Elongation (%) | 2.0 | 1.5 | 2.0 | 2.0 |
| Flexural Strength | 2,800 | 3,100 | 2,800 | 2,650 |
| (kgf/cm²) | | | | |
| Flexural Modulus | 120,000 | 145,000 | 120,000 | 115,000 |
| (kgf/cm²) | | | | |
| IZOD Impact Strength | 12.5 | 10.0 | 13.5 | 10.0 |
| (kgf · cm/cm) | | | | |
| Heat Deformation | 212 | 215 | 212 | 212 |
| Temperature(° C.) | | | | |
| Rockwell Hardness | 120 | 122 | 120 | 120 |
| Fluidity (mm) | 450 | 480 | 400 | 600 |

TABLE 3

| | Comparative Example | | | | | | | |
|---|---|---|---|---|---|---|---|---|
| Section | 1 | 2 | 3 | 4 | 5 | 6 | 7 | 8 |
| Tensile | 1,800 | 1,900 | 1,500 | 1,650 | 1,600 | 1,500 | 2,600 | 1,900 |
| Strength | | | | | | | | |
| (kgf/cm²) | | | | | | | | |
| Elongation | 2.3 | 1.5 | 1.0 | 1.2 | 1.0 | 3.5 | 1.5 | 2.0 |
| (%) | | | | | | | | |
| Flexural | 2,200 | 2,050 | 1,900 | 2,100 | 2,000 | 1,600 | 3,200 | 2,550 |
| Strength | | | | | | | | |
| (kgf/cm²) | | | | | | | | |
| Flexural | 87,000 | 115,000 | 100,000 | 95,000 | 98,000 | 70,000 | 145,000 | 110,000 |
| Modulus | | | | | | | | |
| (kgf/cm²) | | | | | | | | |
| IZOD | 5.0 | 5.5 | 6.0 | 6.5 | 2.5 | 20.0 | 12.0 | 7.0 |
| Impact | | | | | | | | |
| Strength | | | | | | | | |
| (kgf · cm/cm) | | | | | | | | |
| Heat | 210 | 210 | 200 | 203 | 209 | 190 | 215 | 212 |
| Deformation | | | | | | | | |
| Temperature | | | | | | | | |
| (° C.) | | | | | | | | |
| Rockwell | 112 | 115 | 117 | 110 | 118 | 105 | 122 | 120 |
| Hardness | | | | | | | | |
| Fluidity (mm) | 440 | 470 | 450 | 500 | 500 | 350 | 250 | 700 |

According to the results of Tables 2 and 3, it could be confirmed that in the cases of Comparative Examples 1 to 8, which do not include the carbon fiber having longer length (B1), the silane-based coupling agent and the thermoplastic elastomer ingredients, or they are out of the ingredient range or the melt index range, fluidity was reduced, or physical properties such as impact resistance and elastic modulus were deteriorated, as compared to Examples 1 to 4.

On the contrary, it could be confirmed that in the cases of Examples 1 to 4, which include the carbon fiber (B1), the silane-based coupling agent and the thermoplastic elastomer in the polyamide-6 polymer in a proper amount, all of tensile strength, elongation, flexural strength, flexural modulus, impact strength, thermal deformation temperature, Rockwell Hardness and fluidity are evenly improved.

Thus, it could be confirmed that the carbon fiber reinforced thermoplastic resin compositions manufactured in Examples 1 to 4 have an effect of weight reduction and improved economical efficiency due low specific gravity of the resin, further have an advantages of improving parts assembly efficiency and stability by minimizing deformation after injection molding due to substantially improved rigidity, durability and dimensional stability, as compared to the conventional polybutyleneterephthalate/glass fiber material.

As such, the thermoplastic resin composition according to various exemplary embodiments of the present invention may reduce weight of the parts or the resin composition and improve economical efficiency due to low specific gravity of the resin material, further improve parts assembly efficiency and stability by minimizing deformation after injection molding due to substantially improved rigidity, durability and dimensional stability, as compared to the existing polybutyleneterephthalate/glass fiber material. Accordingly, the thermoplastic composition of the present invention may be used as vehicle exterior material for vehicles parts such as a panorama sunroof frame.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A thermoplastic resin composition, comprising:
a polyamide-6 polymer in an amount of about 45 to 93 wt %:
a carbon-fiber in an amount of about 5 to 40 wt %;
a silane-based coupling agent in an amount of about 1 to 5 wt %; and
a thermoplastic elastomer in an amount of about 1 to 10 wt %.
wherein the carbon fiber has a mean section diameter of about 5 to 15 μm and a length of about 5 to 15 mm,
wherein the thermoplastic elastomer has a melt index of about 10 to 40 g/10 min at a temperature of about of about 230° C. and at a load of about 2.16 kg.

2. The thermoplastic resin composition of claim 1, wherein the polyamide-6 polymer has a number average molecular weight of about 20,000 to 70,000.

3. The thermoplastic resin composition of claim 1, wherein the carbon-fiber is made from polyacrylonitrile (PAN), Pitch or a mixture thereof.

4. The thermoplastic resin composition of claim 1, wherein the carbon-fiber comprises a sizing material in an amount of about 0.1 to 3 wt % based on the total weight of the carbon fiber.

5. The thermoplastic resin composition of claim 4, wherein the sizing material is at least one selected from the group consisting of a urethane resin, an acryl resin, a styrene resin and an epoxy resin.

6. The thermoplastic resin composition of claim 1, wherein the silane-based coupling agent is a compound expressed by the following Chemical Formula, 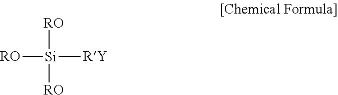
wherein,
each R and R′ are the same or different to each other, and are a hydrogen atom or an optionally substituted alkyl group suitably containing 1 to 30 carbon atoms, and
Y is selected from the group consisting of vinyl group, amino group, methacryl group, epoxy group and mercapto group, each group suitably contains 1 to 20 carbon atoms.

7. The thermoplastic resin composition of claim 1, wherein the thermoplastic elastomer is an ethylene-α-olefin copolymer having a carbon number (α) of 4 or greater, a styrene-diene copolymer or a mixture thereof.

8. The thermoplastic resin composition of claim 1, further comprising an antioxidant selected from the group consisting of a phenol-based antioxidant, a phosphite-based antioxidant and a thiopropionate synergist.

9. A molded article that comprises a thermoplastic resin composition of claim 1.

10. The molded article of claim 9, which is a panorama sunroof frame for a vehicle.

11. A vehicle comprising a molded article of claim 9.
